(19) United States
(12) Patent Application Publication
(10) Pub. No.: US 2024/0342688 A1
(43) Pub. Date: Oct. 17, 2024

(54) MAGNETIC ALUMINUM-BASED ADSORBENT AND PREPARATION METHOD THEREFOR

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Yingsheng Zhong, Foshan, Guangdong (CN); Aixia Li, Foshan, Guangdong (CN); Haijun Yu, Foshan, Guangdong (CN); Yinghao Xie, Foshan, Guangdong (CN); Zhixu Lu, Foshan, Guangdong (CN); Changdong Li, Foshan, Guangdong (CN)

(21) Appl. No.: 18/681,871

(22) PCT Filed: Aug. 31, 2022
(86) PCT No.: PCT/CN2022/116265

§ 371 Date: Feb. 7, 2024

(30) Foreign Application Priority Data
Nov. 26, 2021 (CN) 202111425519.0

(51) Int. Cl. B01J 20/30; B01J 20/08; B01J 20/20; B01J 20/28; B01J 20/32; H01M 10/54

(52) U.S. Cl. CPC B01J 20/3007; B01J 20/08; B01J 20/20; B01J 20/28009; B01J 20/28054; B01J 20/3064; B01J 20/3071; B01J 20/3078; B01J 20/3085; B01J 20/3204; H01M 10/54; B01J 2220/42; B01J 2220/4806

(57) ABSTRACT

Disclosed in the present invention are a magnetic aluminum-based adsorbent and a preparation method therefor. The preparation method comprises the following steps: mixing a carbon black slag powder, porous aluminum oxide and a polar solution, calcining same, then mixing the magnetic powder with a cross-linking agent, then injecting same into a forming mold for treatment and formation, then stripping same, and activating same, so as to obtain the magnetic aluminum-based adsorbent. The magnetic aluminum-based adsorbent prepared by the preparation method has a relatively high adsorption property and can adsorb low-concentration metal ions in wastewater generated by wet recovery of waste batteries well.

### TECHNICAL FIELD

The present application relates to the technical field of preparing adsorbent, in particular to a magnetic aluminum-based adsorbent and a preparation method therefor.

### BACKGROUND

Currently, the methods for recycling valuable metals from waste batteries can be broadly divided into wet-process recycle and pyrogenic-process recycle. The process of the wet-process recycle is as follows: leaching cathode material and anode material by adding a strong oxidizing acid, separating a carbon black slag from the anode material, adding an alkali and iron to the leaching solution for removing aluminum and copper, extracting for separation, adding ammonia and alkali and aging to prepare a ternary precursor. However, the carbon black slag, a meta-aluminate, a sulfate (sulfate of sodium, manganese, cobalt, and nickel) produced in the recycle process are all treated as solid waste and have not been reused with high value. In addition, after the wastewater produced during the wet-process recycle is processed in precipitation by adding alkali, filter press, deamination and sand filtration, it still contains ions of metals such as nickel, cobalt, manganese, sodium, lithium with ultra-low concentrations. It is necessary to use an adsorbent to conduct an adsorption recycle to the residual metal ions in the wastewater. However, the adsorption performance of the existing adsorbent is worse, and the adsorption efficiency needs to be further improved.

### SUMMARY

The present application is directed to solve at least one of the existing technical problems in the prior art. For this end, the present application provides a magnetic aluminum-based adsorbent and a preparation method therefor, wherein the magnetic aluminum-based adsorbent prepared by the preparation method has a stronger absorptivity, which could well absorb the metal ions with a low concentration in wastewater produced in wet-process recycling of waste batteries.

The above-described objectives of the present application are achieved by the technical solutions as below:
a preparation method for a magnetic aluminum-based adsorbent, including the following steps: mixing a carbon black slag powder, a porous alumina with a polar solution, calcining, and then mixing a magnetic powder with a crosslinking agent, injecting the mixture into a forming mold for treatment and molding and stripping off, and then performing an activation treatment to obtain a magnetic aluminum-based adsorbent.

Preferably, the carbon black slag powder is obtained by washing, drying and ball milling the carbon black slag, where the carbon black slag is a product obtained by adding acid to leach battery powder during the wet-process recycling of waste batteries.

Preferably, the particle diameter of the carbon black slag powder is less than 500 μm.

Preferably, the preparation method for the porous alumina is: dissolving a meta-aluminate into water to make a solution, adjusting the pH of the solution to 3.1-3.4 to obtain an aluminum hydroxide precipitate, adjusting the pH of the solution again to 5.8-9.6, and then adding an anti-hydration agent to the solution, stirring, still standing, and washing, drying and calcining the precipitate to obtain a porous alumina, wherein the meta-aluminate is a product obtained by adding acid to leach the battery powder and then adding alkali and carbonate during the wet-process recycling of waste batteries.

Preferably, in the preparation method for the porous alumina, the calcination temperature is 400-600° C., and the duration time of calcination is 4.5-8 h.

Preferably, the anti-hydration agent is at least one of an oxalate and a citrate.

Preferably, the preparation method for a magnetic powder is: dissolving a sulfate in an acid solution, adding oxalic acid and/or oxalate solution to the solution to obtain a precipitate, and then calcining, cooling and magnetically adsorbing the precipitate to prepare a magnetic powder containing nickel and cobalt, wherein the sulfate is a product obtained by adding acid to leach the battery powder during the wet-process recycling of waste batteries, and the main components of the sulfate are sulfates of sodium, manganese, cobalt, and nickel.

Preferably, in the preparation method for the magnetic powder, the concentration of the oxalic acid and/or oxalate solution is 0.1 wt %-40 wt %, and the oxalate is at least one of ammonium oxalate, sodium oxalate, lithium oxalate and potassium oxalate.

Preferably, in the preparation method for a magnetic powder, the calcination process is calcination under anoxic environment, the calcination temperature is 300-350° C., and the duration time of calcination is 3-7 h, wherein the principle of a high-temperature anoxic decomposition of the nickel oxalate and the cobalt oxalate is:

CoC₂O₄·2H₂O+NiC₂O₄·2H₂O→Ni+Co+4CO₂+4H₂O

Preferably, the polar solution is at least one of phenol, tetrahydrofuran, organic acid, n-butanol, butanol, propanol, glycerin, ethanol, and acetic acid.

Preferably, the crosslinking agent is at least one of methyl enoate, styrene, vinylamines and m-phenylenediamine.

Preferably, a ratio of the mass of the carbon black slag powder, to the mass of the porous alumina and to the volume of the polar solution (w/w/v) is (20-60):(160-200):(160-200).

Preferably, a ratio of the volume of the crosslinking agent to the mass of magnetic powder (v/w) is (15-50):(60-100).

Preferably, the porous alumina is mixed with the polar solution and the mixture is injected into the forming mold for calcining, wherein the calcination temperature is 250-450° C., and the duration time of calcination is 1-3.5 h.

Preferably, the forming mold is provided with a first molding tank and a plurality of second molding tanks being symmetrically arranged, wherein the first molding tank is in communication with the second molding tanks; after the carbon black slag powder are mixed with the porous alumina and the polar solution, the mixture is injected and filled into the first molding tank of the forming mold for calcining; and after the magnetic powder is mixed with the crosslinking agent, the mixture is injected and filled into the second molding tanks of the forming mold.

Preferably, the activation treatment is a treatment of soaking the stripped product into a hot acid at 50-60° C.

More preferably, the acid used in the activation treatment is 0.001-0.2 M of at least one of sulfuric acid, hydrochloric acid, nitric acid, and phosphoric acid.

A magnetic aluminum-based adsorbent is prepared by the above-described preparation method.

Use of the above-described magnetic aluminum-based adsorbent in the treatment of wastewater produced by the wet-process recycling of waste batteries is provided.

The beneficial effects achieved by the present application are as follow:

(1) The magnetic aluminum-based adsorbent prepared by the preparation method for the magnetic aluminum-based adsorbent of the present invention has a relatively strong adsorption capacity to the ions of nickel, cobalt, manganese, sodium and lithium in the wastewater produced by the wet-process recycling of waste batteries. On the one hand, the addition of carbon black slag powder can improve the polarity and acid-base properties of the aluminum-based adsorbent, improve the mechanical strength of the adsorbent, and prevent it from swelling and breaking when being immersed in wastewater. On the other hand, the adsorption performance of magnetic aluminum-based adsorbent to the metal ions in wastewater can be significantly improved after being subjected to an activation treatment.

(2) During the preparation method for the magnetic aluminum-based adsorbent of the present invention, in the preparation of the porous alumina, when the aluminum hydroxide is precipitated and calcined, as the temperature rises, the aluminum hydroxide is gradually dehydrated into alumina, and most of the water molecules are still attached on its surface by linking of the hydrogen bonds. When the temperature reaches 200° C., most of the water is desorbed at high temperature, and a small amount of water reacts with alumina to produce —OH, and the —OH is condensed to dehydrate part of Al³⁺, so the obtained porous alumina can be adsorbed with water and cations. At the same time, a stable chelate structure is produced by the added citrate/oxalate and Al³⁺, which can prevent H₂O and Al³⁺ from contacting to generate a phenomenon of hydration, and prevent H₂O from blocking the ion channels of the adsorbent or occupying the active sites that can adsorb ions, thereby improving the adsorption capacity of the prepared magnetic aluminum-based adsorbent.

(3) Currently, in the market, the aluminum source of the aluminum-based adsorbent comes from metallic aluminum, which is expensive, and the modification process is complicated and a large amount of chemical raw materials are required. However, the sources of the magnetic aluminum-based adsorbent synthesized in the preparation method of the present invention all come from the products obtained in the recycling of the waste batteries. The meta-aluminate, sulfate, and carbon black slag are all products obtained by acid oxidation leaching battery powder or solid waste obtained in the battery recycling process. Therefore, the main material of the adsorbent comes from the reutilization of the waste material. In addition, the magnetic aluminum-based adsorbent synthesized in the present invention can be reutilized with a high recyclability.

### BRIEF DESCRIPTION OF THE DRAWINGS

FIG. 1 is a schematic diagram of a forming mold according to example 1;

FIG. 2 is a SEM image of a magnetic aluminum-based adsorbent according to example 1;

FIG. 3 is a SEM image of a magnetic aluminum-based adsorbent according to example 3;

FIG. 4 is an isothermal graph of the N₂ adsorption-desorption of the magnetic aluminum-based adsorbent according to example 1;

FIG. 5 is a distribution graph of a pore width of the magnetic aluminum-based adsorbent according to example 1;

FIG. 6 is an isothermal graph of N₂ adsorption-desorption of the magnetic aluminum-based adsorbent according to example 3; and

FIG. 7 is a distribution graph of a pore width of the magnetic aluminum-based adsorbent according to example 3.

### NUMERAL REFERENCE

first molding tank 101, second molding tank 102.

### DETAILED DESCRIPTION OF THE EMBODIMENTS

The present application will be further described below in conjunction with specific Examples.

### Example 1

A preparation method for a magnetic aluminum-based adsorbent comprised the following steps.
(1) Preparation of a carbon black slag powder: a carbon black slag was washed with water, dried and ball milled to a particle size less than 500 μm so as to obtain 1.2 kg of carbon black slag powder, wherein the carbon black slag was a product obtained by adding acid to leach battery powder during the wet-process recycling of waste batteries.

(2) Preparation of porous alumina: 0.2 kg of meta-aluminate was dissolved in water to make a solution, air was aerated and the pH was adjusted to 3.1 to obtain an aluminum hydroxide precipitate, then a sodium hydroxide solution was added to the solution to adjust the pH to 5.8, then 1.5% of sodium citrate was added, and the mixture was stirred and still stood, and the precipitate was washed and dried, and then put in a tube furnace for calcination at 403° C. for 8 hours to obtain 235 g of porous alumina, wherein the meta-aluminate was a product obtained by adding acid to leach the battery powder and then adding alkali and carbonate during the wet-process recycling of waste batteries.

(3) Preparation of a magnetic powder: 0.45 kg of sulfate was dissolved in 3 L of 0.35 M sulfuric acid solution, then 14.1% of sodium oxalate solution was dropwise added to the solution to obtain precipitate of nickel oxalate and cobalt oxalate, and then the precipitate was put in a tube furnace, dehydrated, air eliminated, calcined at 320° C. for 6 h and 23 min under anoxic environment, and cooled and magnetically adsorbed to prepare 127 g of magnetic powder containing nickel and cobalt, which was anti-oxidation preserved, wherein the sulfate was a product obtained by adding acid to leach the battery powder during the wet-process recycling of waste batteries.

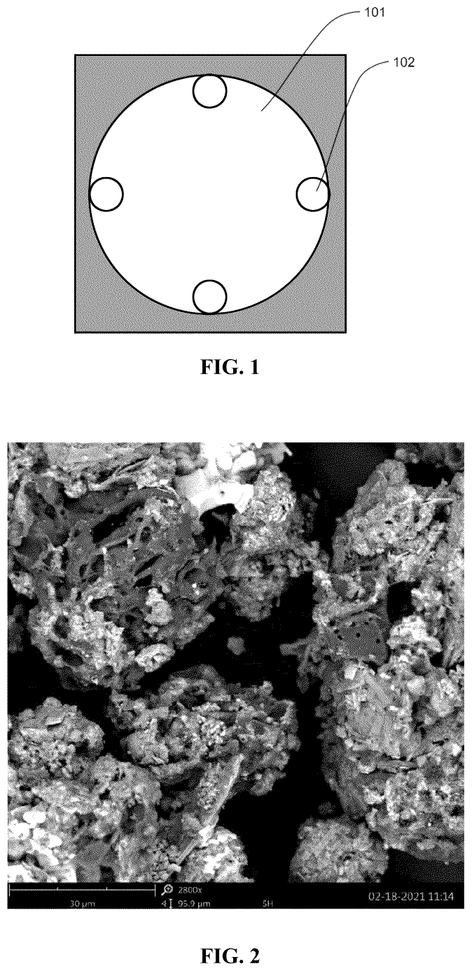

(4) Preparation of a forming mold, as shown in FIG. 1, the forming mold was provided with a circular first molding tank 101 and four circular second molding tanks 102 being symmetrically arranged. The first molding tank 101 was in communication with the second molding tanks 102. The carbon black slag powder, porous alumina, and propanol were stirred and mixed in a water bath kettle at a constant temperature of 40° C., and then the mixture was injected and filled into the first molding tank 101 of the forming mold, wherein carbon black slag powder:porous alumina:propanol (g/g/mL)=30:200:170. The forming mold was put in a tube furnace after being still stood, calcined at 450° C. for 1 h and 10 min, and then the forming mold was taken out. The magnetic powder was mixed with styrene and then the mixture was injected and filled into the second molding tanks 102 of the forming mold, wherein styrene:magnetic powder (mL/g)=50:100, and then the forming mold was put in the tube furnace and heated at 80° C. for 45 minutes, cooled and cured. The mold was stripped off. The product was subjected to an activation treatment, washed with water, and dried to obtain a magnetic aluminum-based adsorbent, wherein the activation treatment was a treatment of soaking the stripped product in 0.054 M sulfuric acid at 55° C. for 1 h and 15 min.

### Example 2

A preparation method for a magnetic aluminum-based adsorbent comprised the following steps.

(1) Preparation of a carbon black slag powder: a carbon black slag was washed with water, dried and ball milled to a particle size less than 500 μm so as to obtain 1.2 kg of carbon black slag powder, wherein the carbon black slag was a product obtained by adding acid to leach battery powder during the wet-process recycling of waste batteries.

(2) Preparation of porous alumina: 0.2 kg of meta-aluminate was dissolved in water to make a solution, air was aerated and the pH was adjusted to 3.4 to obtain an aluminum hydroxide precipitate, then a sodium hydroxide solution was added to the solution to adjust the pH to 9.6, then 1.5% of sodium citrate was added, and the mixture was stirred and still stood, and the precipitate was washed and dried, and then put in a tube furnace for calcination at 530° C. for 6 h and 14 min to obtain 233 g of porous alumina, wherein the meta-aluminate was a product obtained by adding acid to leach the battery powder and then adding alkali and carbonate during the wet-process recycling of waste batteries.

(3) Preparation of a magnetic powder: 0.45 kg of sulfate was dissolved in 3.5 L of 0.35 M sulfuric acid solution, then sodium oxalate solution with a concentration of 14.1% was dropwise added to the solution to obtain precipitate of nickel oxalate and cobalt oxalate, and then the precipitate was put in a tube furnace, dehydrated, air eliminated, calcined at 330° C. for 5 h and 27 min under anoxic environment, and cooled and magnetically adsorbed to prepare 122 g of magnetic powder containing nickel and cobalt, which was anti-oxidation preserved, wherein the sulfate was a product obtained by adding acid to leach the battery powder during the wet-process recycling of waste batteries.

(4) Preparation of a forming mold: the forming mold was provided with a circular first molding tank and four circular second molding tanks being symmetrically arranged. The first molding tank was in communication with the second molding tanks. The carbon black slag powder, porous alumina, and propanol were stirred and mixed in a water bath kettle at a constant temperature of 40° C., and then the mixture was injected and filled into the first molding tank of the forming mold, wherein carbon black slag powder:porous alumina:propanol (g/g/mL)=20:200:160. The forming mold was put in a tube furnace after being still stood, calcined at 325° C. for 1 h and 36 min, and then the forming mold was taken out. The magnetic powder was mixed with methyl enoate, and then the mixture was injected and filled into the second molding tank of the forming mold, wherein methyl enoate:magnetic powder (mL/g)=45:100, and then the forming mold was put in a tube furnace at 80° C. and heated for 45 minutes, cooled and cured. The mold was stripped off. The product was subjected to an activation treatment, washed with water, and dried to obtain a magnetic aluminum-based adsorbent, wherein the activation treatment was a treatment of soaking the stripped product in 0.054 M sulfuric acid at 55° C. for 50 min.

### Example 3

A preparation method for a magnetic aluminum-based adsorbent comprised the following steps.

(1) Preparation of a carbon black slag powder: a carbon black slag was washed with water, dried and ball milled to a particle size less than 500 μm so as to obtain 1.2 kg of carbon black slag powder, wherein the carbon black slag was a product obtained by adding acid to leach battery powder during the wet-process recycling of waste batteries.

(2) Preparation of porous alumina: 0.2 kg of meta-aluminate was dissolved in water to make a solution, air was aerated and the pH was adjusted to 3.3 to obtain an aluminum hydroxide precipitate, then a sodium hydroxide solution was added to the solution to adjust the pH to 7.7, then 1.5% of sodium oxalate was added, and the mixture was stirred and still stood, and the precipitate was washed and dried, and then put in a tube furnace for calcination at 590° C. for 4.5 h to obtain 235 g of porous alumina, wherein the meta-aluminate was a product obtained by adding acid to leach the battery powder and then adding alkali and carbonate during the wet-process recycling of waste batteries.

(3) Preparation of a magnetic powder: 0.45 kg of sulfate was dissolved in 4 L of 0.35 M sulfuric acid solution, then 14.1% of sodium oxalate solution was dropwise added to the solution to obtain precipitate of nickel oxalate and cobalt oxalate, and then the precipitate was put in a tube furnace, dehydrated, air eliminated, calcined at 350° C. for 3 h and 52 min under anoxic environment, and cooled and magnetically adsorbed to prepare 124 g of magnetic powder containing nickel and cobalt, which was anti-oxidation preserved, wherein the sulfate was a product obtained by adding acid to leach the battery powder during the wet-process recycling of waste batteries.

(4) Preparation of a forming mold: the forming mold was provided with a circular first molding tank and four circular second molding tanks being symmetrically arranged. The first molding tank was in communication with the second molding tanks. The carbon black slag powder, porous alumina, and butanol were stirred and mixed in a water bath kettle at a constant temperature of 40° C., and then the mixture was injected and filled into the first molding tank of the forming mold, wherein carbon black slag powder:porous alumina:butanol (g/g/mL)=60:160:200. The forming mold was put in a tube furnace after being still stood, calcined at 335° C. for 2 h and 10 min, and then the forming mold was taken out. The magnetic powder was mixed with diethylenetriamine, and then the mixture was injected and filled into the second molding tank of the forming mold, wherein diethylenetriamine:magnetic powder (mL/g)=40:100, and then the forming mold was put in a tube furnace at 80° C. and heated for 45 minutes, cooled and cured. The mold was stripped off. The product was subjected to an activation treatment, washed with water, and dried to obtain a magnetic aluminum-based adsorbent, wherein the activation treatment was a treatment of soaking the stripped product in 0.054 M sulfuric acid at 55° C. for 40 min.

### Example 4

A preparation method for a magnetic aluminum-based adsorbent comprised the following steps.

(1) Preparation of a carbon black slag powder: a carbon black slag was washed with water, dried and ball milled to a particle size less than 500 μm so as to obtain 1.2 kg of carbon black slag powder, wherein the carbon black slag was a product obtained by adding acid to leach battery powder during the wet-process recycling of waste batteries.

(2) Preparation of porous alumina: 0.2 kg of meta-aluminate was dissolved in water to make a solution, air was aerated and the pH was adjusted to 3.3 to obtain an aluminum hydroxide precipitate, then a sodium hydroxide solution was added to the solution to adjust the pH to 7.4, then 1.5% of sodium citrate was added, and the mixture was stirred and still stood, and the precipitate was washed and dried, and then put in a tube furnace for calcination at 520° C. for 4.5 hours to obtain 233 g of porous alumina, wherein the meta-aluminate was a product obtained by adding acid to leach the battery powder and then adding alkali and carbonate during the wet-process recycling of waste batteries.

(3) Preparation of a magnetic powder: 0.45 kg of sulfate was dissolved in 3 L of 0.17 M sulfuric acid solution, then 17.8% of sodium oxalate solution was dropwise added to the solution to obtain precipitate of nickel oxalate and cobalt oxalate, and then the precipitate was put in a tube furnace, dehydrated, air eliminated, calcined at 316° C. for 4 h and 20 min under anoxic environment, and cooled and magnetically adsorbed to prepare 124 g of magnetic powder containing nickel and cobalt, which was anti-oxidation preserved, wherein the sulfate was a product obtained by adding acid to leach the battery powder during the wet-process recycling of waste batteries.

(4) Preparation of a forming mold: the forming mold was provided with a circular first molding tank and four circular second molding tanks being symmetrically arranged. The first molding tank was in communication with the second molding tanks. The carbon black slag powder, porous alumina, and propanol were stirred and mixed in a water bath kettle at a constant temperature of 40° C., and then the mixture was injected and filled into the first molding tank of the forming mold, wherein carbon black slag powder:porous alumina:propanol (g/g/mL)=40:160:160. The forming mold was put in a tube furnace after being still stood, calcined at 278° C. for 2 h and 40 min, and then the forming mold was taken out. The magnetic powder was mixed with diethylenetriamine and then the mixture was injected and filled into the second molding tanks of the forming mold, wherein diethylenetriamine:magnetic powder (mL/g)=32:80, and then the forming mold was put in the tube furnace and heated at 80° C. for 45 minutes, cooled and cured. The mold was stripped off. The product was subjected to an activation treatment, washed with water, and dried to obtain a magnetic aluminum-based adsorbent, wherein the activation treatment was a treatment of soaking the stripped product in 0.027 M sulfuric acid at 55° C. for 50 min.

### Example 5

A preparation method for a magnetic aluminum-based adsorbent comprised the following steps.

(1) Preparation of a carbon black slag powder: a carbon black slag was washed with water, dried and ball milled to a particle size less than 500 μm so as to obtain 1.2 kg of carbon black slag powder, wherein the carbon black slag was a product obtained by adding acid to leach battery powder during the wet-process recycling of waste batteries.

(2) Preparation of porous alumina: 0.2 kg of meta-aluminate was dissolved in water to make a solution, air was aerated and the pH was adjusted to 3.4 to obtain an aluminum hydroxide precipitate, then a sodium hydroxide solution was added to the solution to adjust the pH to 7.4, then 1.5% of sodium citrate was added, and the mixture was stirred and still stood, and the precipitate was washed and dried, and then put in a tube furnace for calcination at 520° C. for 4.5 hours to obtain 231 g of porous alumina, wherein the meta-aluminate was a product obtained by adding acid to leach the battery powder and then adding alkali and carbonate during the wet-process recycling of waste batteries.

(3) Preparation of a magnetic powder: 0.45 kg of sulfate was dissolved in 4 L of 0.17 M sulfuric acid solution, then 17.8% of sodium oxalate solution was dropwise added to the solution to obtain precipitate of nickel oxalate and cobalt oxalate, and then the precipitate was put in a tube furnace, dehydrated, air eliminated, calcined at 316° C. for 3 h and 45 min under anoxic environment, and cooled and magnetically adsorbed to prepare 126 g of magnetic powder containing nickel and cobalt, which was anti-oxidation preserved, wherein the sulfate was a product obtained by adding acid to leach the battery powder during the wet-process recycling of waste batteries.

(4) Preparation of a forming mold: the forming mold was provided with a circular first molding tank and four circular second molding tanks being symmetrically arranged. The first molding tank was in communication with the second molding tanks. The carbon black slag powder, porous alumina, and propanol were stirred and mixed in a water bath kettle at a constant temperature of 40° C., and then the mixture was injected and filled into the first molding tank of the forming mold, wherein carbon black slag powder:porous alumina:propanol (g/g/mL)=40:200:160. The forming mold was put in a tube furnace after being still stood, calcined at 430° C. for 3 h and 27 min, and then the forming mold was taken out. The magnetic powder was mixed with m-phenylenediamine and then the mixture was injected and filled into the second molding tanks of the forming mold, wherein m-phenylenediamine:magnetic powder (mL/g)=15:60, and then the forming mold was put in the tube furnace and heated at 80° C. for 45 minutes, cooled and cured. The mold was stripped off. The product was subjected to an activation treatment, washed with water, and dried to obtain a magnetic aluminum-based adsorbent, wherein the activation treatment was a treatment of soaking the stripped product in 0.027 M sulfuric acid at 52° C. for 40 min.

### Comparative Example 1

A preparation method for a magnetic aluminum-based adsorbent comprised the following steps.

(1) Preparation of a carbon black slag powder: a carbon black slag was washed with water, dried and ball milled to a particle size less than 500 μm so as to obtain 1.2 kg of carbon black slag powder, wherein the carbon black slag was a product obtained by adding acid to leach battery powder during the wet-process recycling of waste batteries.

(2) Preparation of porous alumina: 0.2 kg of meta-aluminate was dissolved in water to make a solution, air was aerated and the pH was adjusted to 3.1 to obtain an aluminum hydroxide precipitate, then a sodium hydroxide solution was added to the solution to adjust the pH to 5.8, then 1.5% of sodium citrate was added, and the mixture was stirred and still stood, and the precipitate was washed and dried, and then put in a tube furnace for calcination at 403° C. for 8 hours to obtain 235 g of porous alumina, wherein the meta-aluminate was a product obtained by adding acid to leach the battery powder and then adding alkali and carbonate during the wet-process recycling of waste batteries.

(3) Preparation of a magnetic powder: 0.45 kg of sulfate was dissolved in 3 L of 0.35 M sulfuric acid solution, then 14.1% of sodium oxalate solution was dropwise added to the solution to obtain precipitate of nickel oxalate and cobalt oxalate, and then the precipitate was put in a tube furnace, dehydrated, air eliminated, calcined at 320° C. for 6 h and 23 min under anoxic environment, and cooled and magnetically adsorbed to prepare 127 g of magnetic powder containing nickel and cobalt, which was anti-oxidation preserved, wherein the sulfate was a product obtained by adding acid to leach the battery powder during the wet-process recycling of waste batteries.

(4) Preparation of a forming mold: the forming mold was provided with a circular first molding tank and four circular second molding tanks being symmetrically arranged. The first molding tank was in communication with the second molding tanks. The carbon black slag powder, porous alumina, and propanol were stirred and mixed in a water bath kettle at a constant temperature of 40° C., and then the mixture was injected and filled into the first molding tank of the forming mold, wherein carbon black slag powder:porous alumina:propanol (g/g/mL)=30:200:170. The forming mold was put in a tube furnace after being still stood, calcined at 450° C. for 1 h and 10 min, and then the forming mold was taken out. The magnetic powder was mixed with styrene and then the mixture was injected and filled into the second molding tanks of the forming mold, wherein styrene:magnetic powder (mL/g)=50:100, and then the forming mold was put in the tube furnace and heated at 80° C. for 45 minutes, cooled and cured.

The mold was stripped off. The product was washed with water, and dried to obtain a magnetic aluminum-based adsorbent.

### Comparative Example 2

A preparation method for a magnetic aluminum-based adsorbent comprised the following steps.

(1) Preparation of a carbon black slag powder: a carbon black slag was washed with water, dried and ball milled to a particle size less than 500 μm so as to obtain 1.2 kg of carbon black slag powder, wherein the carbon black slag was a product obtained by adding acid to leach battery powder during the wet-process recycling of waste batteries.

(2) Preparation of porous alumina: 0.2 kg of meta-aluminate was dissolved in water to make a solution, air was aerated and the pH was adjusted to 3.1 to obtain an aluminum hydroxide precipitate, then a sodium hydroxide solution was added to the solution to adjust the pH to 5.8, and the mixture was stirred and still stood, and the precipitate was washed and dried, and then put in a tube furnace for calcination at 403° C. for 8 hours to obtain 235 g of porous alumina, wherein the meta-aluminate was a product obtained by adding acid to leach the battery powder and then adding alkali and carbonate during the wet-process recycling of waste batteries.

(3) Preparation of a magnetic powder: 0.45 kg of sulfate was dissolved in 3 L of 0.35 M sulfuric acid solution, then 14.1% of sodium oxalate solution was dropwise added to the solution to obtain precipitate of nickel oxalate and cobalt oxalate, and then the precipitate was put in a tube furnace, dehydrated, air eliminated, calcined at 320° C. for 6 h and 23 min under anoxic environment, and cooled and magnetically adsorbed to prepare 127 g of magnetic powder containing nickel and cobalt, which was anti-oxidation preserved, wherein the sulfate was a product obtained by adding acid to leach the battery powder during the wet-process recycling of waste batteries.

(4) Preparation of a forming mold: the forming mold was provided with a circular first molding tank and four circular second molding tanks being symmetrically arranged. The first molding tank was in communication with the second molding tanks. The carbon black slag powder, porous alumina, and propanol were stirred and mixed in a water bath kettle at a constant temperature of 40° C., and then the mixture was injected and filled into the first molding tank of the forming mold, wherein carbon black slag powder:porous alumina:propanol (g/g/mL)=30:200:170. The forming mold was put in a tube furnace after being still stood, calcined at 450° C. for 1 h and 10 min, and then the forming mold was taken out. The magnetic powder was mixed with styrene and then the mixture was injected and filled into the second molding tanks of the forming mold, wherein styrene:magnetic powder (mL/g)=50:100, and then the forming mold was put in the tube furnace and heated at 80° C. for 45 minutes, cooled and cured. The mold was stripped off. The product was subjected to an activation treatment, washed with water, and dried to obtain a magnetic aluminum-based adsorbent; wherein the activation treatment was treatment of soaking the stripped product in 0.054 M sulfuric acid at 55° C. for 1 h and 15 min.

### Test Example

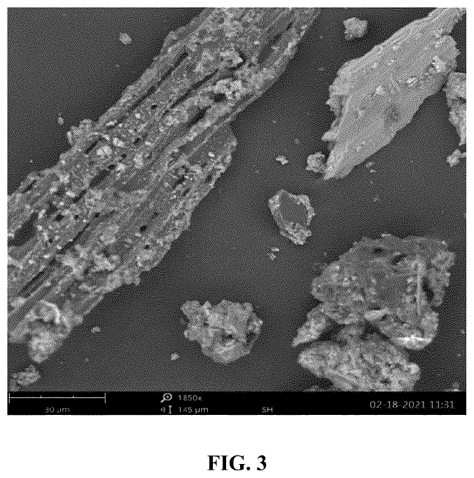

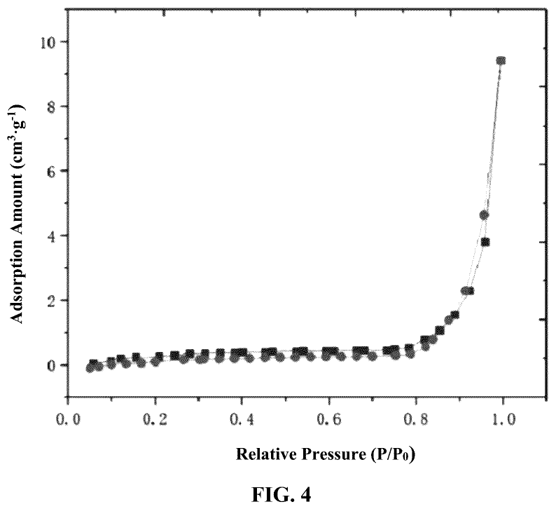

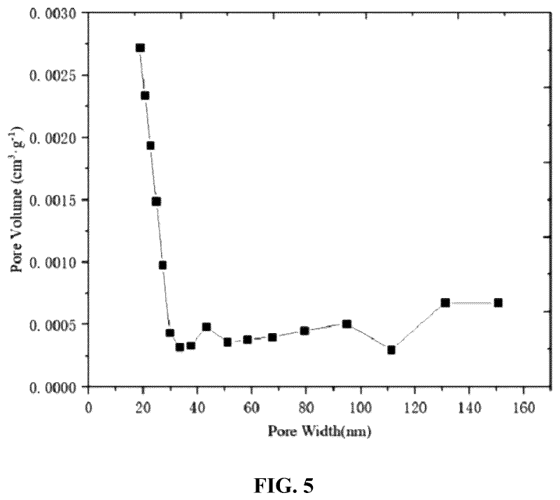

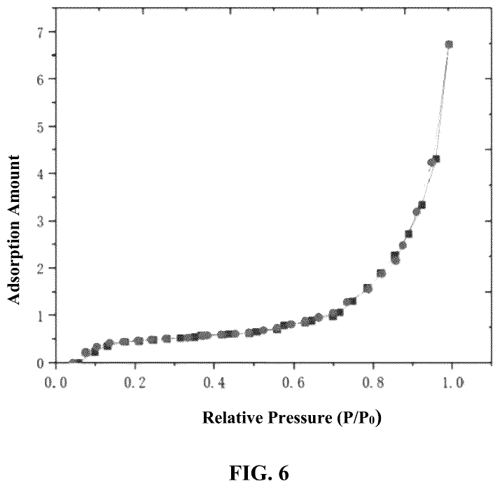

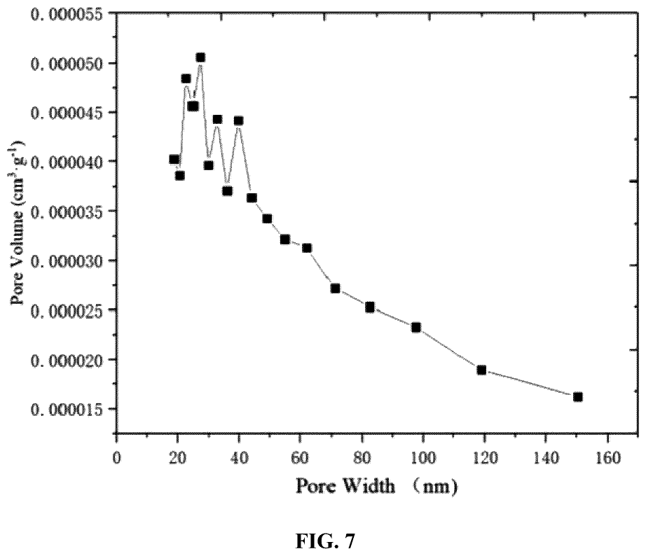

The magnetic aluminum-based adsorbents prepared in Examples 1-5 and Comparative Example 1-2 were used to adsorb metal ions in the wastewater produced by wet-process recycling of waste batteries, respectively. The adsorption method was as follows: 0.16 kg of magnetic aluminum-based adsorbent was placed in a container with two pairs of magnets, 2 L of wastewater was injected, adsorption was conducted for 3 hours, and then the adsorbent was taken out. The adsorbent was washed with sodium hydroxide solution in concentration of 0.015 M, desorbed, washed with water, and dried at 150° C., and then adsorption was performed repeatedly. The adsorption was performed for totally 3 times and a total time of 9 hours. The content of relevant metal ions in the wastewater before and after adsorption was tested. A removal rate of relevant metal ions was calculated, and the removal rate of relevant metal ions was shown in Table 1. A morphology of the magnetic aluminum-based adsorbent prepared in Example 1 and Example 3 was observed by scanning electron microscope, and the results were shown in FIGS. 2 and 3. N₂ isothermal adsorption-desorption test of the magnetic aluminum-based adsorbent prepared in Example 1 and Example 3 was conducted, and the test results were shown in FIGS. 4 and 6. A test to the magnetic aluminum-based adsorbents prepared in Example 1 and Example 3 was conducted by an automatic specific surface area analyzer and an inductively coupled plasma emission spectrometer, and the test results were shown in FIGS. 5 and 7.

TABLE 1
the removal rates of the relevant metal ions in wastewater.

| | Manganese | Cobalt | Nickel | Sodium | Lithium |
|---|---|---|---|---|---|
| | removal | removal | removal | removal | removal |
| Items | rate(%) | rate(%) | rate(%) | rate(%) | rate(%) |
| Example 1 | 86.78 | 83.13 | 73.78 | 56.13 | 54.12 |
| Example 2 | 83.32 | 89.54 | 76.32 | 59.57 | 54.40 |
| Example 3 | 86.95 | 87.39 | 71.34 | 57.31 | 55.72 |
| Example 4 | 84.61 | 87.13 | 83.44 | 58.16 | 53.27 |
| Example 5 | 82.40 | 84.78 | 71.07 | 55.10 | 59.63 |
| Comparative | 71.52 | 80.19 | 68.39 | 56.07 | 45.29 |
| example 1 | | | | | |
| Comparative | 69.35 | 78.51 | 65.25 | 53.52 | 47.72 |
| example 2 | | | | | |

As can be seen from table 1, the magnetic aluminum-based adsorbent prepared by the preparation method for the magnetic aluminum-based adsorbent of the present invention has a relatively strong absorptivity. After the wastewater produced in wet-process recycling of waste batteries is subjected to the adsorption by the magnetic aluminum-based adsorbent prepared by the preparation method for the magnetic aluminum-based adsorbent of the present invention, the removal rate of relevant metal ions is above 53%, and the highest can reach 89.54%.

It can be seen by comparing Example 1 and Comparative Example 1 that, when the process of the activation treatment is cancelled while other conditions and parameters remain unchanged, the removal rate of the relevant metal ions in wastewater removed by the final prepared magnetic aluminum-based adsorbent is only 45.29%-80.19%. The adsorption performance is significantly decreased, which indicates that the adsorption performance of the magnetic aluminum-based adsorbent can be significantly improved after being subjected to the activation treatment. It can be seen by comparing Example 1 and Comparative Example 2 that, when no anti-hydrating agent is added during the preparation of the porous alumina while other conditions and parameters remain unchanged, the removal rate of the relevant metal ions in wastewater removed by the final prepared magnetic aluminum-based adsorbent is only 47.72%-78.51%. The adsorption performance is significantly decreased, which indicates that the adsorption performance of the magnetic aluminum-based adsorbent can be significantly improved by addition of an anti-hydrating agent during the preparation of the porous alumina.

It can be seen from FIGS. 2 and 3 that the magnetic aluminum-based adsorbents of Examples 1 and 3 prepared by the preparation method of the present invention have a loose and porous structure.

It can be seen from FIGS. 4 and 6 that the isothermal graphs of adsorption-desorption of Examples 1 and 3 obtained by the preparation method of the present invention all belong to isotherms in Type II.

It can be seen from FIGS. 5 and 7 that a pore width of the magnetic aluminum-based adsorbent of Examples 1 and 3 prepared by the preparation method of the present invention is 20-145 nm, wherein the pore width of the magnetic aluminum-based adsorbent of Example 1 is substantially 20-35 nm, and the pore width of the magnetic aluminum-based adsorbent in Example 3 is substantially 20-60 nm.

The above-mentioned Examples are preferred embodiments of the present invention, but the embodiments of the present invention are not limited to the above-mentioned Examples. Various changes, modifications, substitutions, combinations, and simplification, etc. made without departing from the spirit and principle of the present invention should be equivalent replacement modes, and should be considered as falling in the scope of the present application.

1. A preparation method for a magnetic aluminum-based adsorbent, comprising the following steps: mixing a carbon black slag powder, a porous alumina with a polar solution, calcining, and then mixing a magnetic powder with a crosslinking agent, injecting the mixture into a forming mold for treatment and molding and stripping off, and then performing an activation treatment to obtain a magnetic aluminum-based adsorbent.

2. The preparation method for a magnetic aluminum-based adsorbent according to claim 1, wherein the preparation method for the porous alumina comprises: dissolving a meta-aluminate into water to make a solution, adjusting the pH of the solution to 3.1-3.4 to obtain an aluminum hydroxide precipitate, adjusting the pH of the solution again to 5.8-9.6, and then adding an anti-hydration agent to the solution, stirring, still standing, and washing, drying and calcining the precipitate to obtain a porous alumina, wherein the meta-aluminate is a product obtained by adding acid to leach battery powder and then adding alkali and carbonate during the wet-process recycling of waste batteries.

3. The preparation method for a magnetic aluminum-based adsorbent according to claim 2, wherein the anti-hydration agent is at least one of an oxalate and a citrate.

4. The preparation method for a magnetic aluminum-based adsorbent according to claim 1, wherein the preparation method for the magnetic powder comprises: dissolving a sulfate in an acid solution, adding oxalic acid and/or oxalate solution to the solution to obtain a precipitate, and then calcining, cooling and magnetically adsorbing the precipitate to prepare a magnetic powder containing nickel and cobalt, wherein the sulfate is a product obtained by adding acid to leach the battery powder during the wet-process recycling of waste batteries.

5. The preparation method for a magnetic aluminum-based adsorbent according to claim 1, wherein the polar solution is at least one of phenol, tetrahydrofuran, organic acid, n-butanol, butanol, propanol, glycerin, ethanol, and acetic acid.

6. The preparation method for a magnetic aluminum-based adsorbent according to claim 1, wherein the crosslinking agent is at least one of methyl enoate, styrene, vinylamines and m-phenylenediamine.

7. The preparation method for a magnetic aluminum-based adsorbent according to claim 1, wherein a ratio of the mass of the carbon black slag powder, to the mass of the porous alumina and to the volume of the polar solution is (20-60):(160-200):(160-200).

8. The preparation method for a magnetic aluminum-based adsorbent according to claim 1, wherein the forming mold is provided with a first molding tank and a plurality of second molding tanks being symmetrically arranged, wherein the first molding tank is in communication with the second molding tanks; wherein after the carbon black slag powder are mixed with the porous alumina and the polar solution, the mixture is injected and filled into the first molding tank of the forming mold for calcining; after the magnetic powder is mixed with the crosslinking agent, the mixture is injected and filled into the second molding tanks of the forming mold.

9. The preparation method for a magnetic aluminum-based adsorbent according to claim 1, wherein the activation treatment is a treatment of soaking the stripped product into a hot acid at 30-60° C.

10. A magnetic aluminum-based adsorbent prepared by the preparation method according to claim 1.

11. A magnetic aluminum-based adsorbent prepared by the preparation method according to claim 2.

12. A magnetic aluminum-based adsorbent prepared by the preparation method according to claim 3.

13. A magnetic aluminum-based adsorbent prepared by the preparation method according to claim 4.

14. A magnetic aluminum-based adsorbent prepared by the preparation method according to claim 5.

15. A magnetic aluminum-based adsorbent prepared by the preparation method according to claim 6.

16. A magnetic aluminum-based adsorbent prepared by the preparation method according to claim 7.

17. A magnetic aluminum-based adsorbent prepared by the preparation method according to claim 8.

18. A magnetic aluminum-based adsorbent prepared by the preparation method according to claim 9.
